(19) United States
(12) Patent Application Publication
(10) Pub. No.: US 2003/0116603 A1
(43) Pub. Date: Jun. 26, 2003

(54) Fastener Driving tools

(76) Inventors: Robert Urquhart Connell, Hawthorn (AU); Peter John O'Connor, Croydon Hills (AU); Ian Ross Ferrier, Wantirna South (AU); David John McCullough, Hawthorn East (AU)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/282,245

(22) Filed: Oct. 29, 2002

(30) Foreign Application Priority Data
Oct. 30, 2001 (AU) PR8575/01

(51) Int. Cl. B25C 1/12

(52) U.S. Cl. 227/10

(57) ABSTRACT

An explosively actuated tool for driving a fastener into a substrate is of indirect acting type having a driving piston mounted within the barrel of the tool for driving the fastener. The tool is a single shot tool which receives an explosive charge, particularly a .22 cal×0.613 ins long unnecked charge capable of generating a piston kinetic energy of at least 260 joule. The piston has a recess in its rear face able to smooth-out sharp pressure spikes and reduce peak pressure generated during combustion of the high powered explosive charge.

### BACKGROUND OF THE INVENTION

1) Field of the Invention

The present invention relates to explosively actuated fastener driving tools for driving a fastener such as a pin into a hard substrate such as concrete or steel.

2) Description of the Prior Art

Explosively actuated fastener driving tools are either of direct acting type or indirect acting type. In direct acting tools, the gases generated by firing of an explosive charge directly drive a fastener from the barrel of the tool at high velocity into the substrate. In indirect acting tools, firing of the charge drives a piston and this in turn drives the fastener from the barrel of the tool. The driving energy applied to the fastener is dependent on the mass and velocity of the piston, but as the piston itself is a substantial component and many times heavier than the fastener this does mean that in an indirect acting tool the fastener will be driven at a significantly lower velocity and hence at substantially lower kinetic energy than in a comparable direct acting tool. Safety concerns may arise in some working situations involving the use of direct acting tools associated with the high driving velocity of the fastener and circumstances can arise in which if the fastener is incorrectly positioned relative to the underlying substrate, the tool can drive the fastener completely through an outer component (such as wooden formwork) clear of the substrate whereby the fastener then exits the outer component possibly into open air rather like a bullet with potentially serious consequences.

So-called single shot direct acting tools, however, have been widely used in the construction industry for many years and are popular amongst users. They are particularly suitable for low volume applications. A single explosive charge is loaded manually into a charge chamber of the tool, and the fastener is loaded into the forward end of the barrel assembly. The popularity of these tools arises due to their relative simplicity whereby they are easy to use and are not prone to breakdown and also to their high power output.

### SUMMARY OF THE INVENTION

The applicants have determined the desirability of producing a single shot indirect acting tool which replicates many of the desirable characteristics of direct acting tools particularly in terms of high power output.

According to the present invention there is provided an explosively actuated tool for driving a fastener into a substrate, said tool being of indirect acting type and comprising a driving piston mounted within a barrel of the tool for driving the fastener, wherein the tool is a single shot tool able to receive an explosive charge capable of generating a piston kinetic energy of at least 260 joule.

Further according to the invention there is provided an explosively actuated tool for driving a fastener into a substrate, said tool being of indirect acting type and comprising a driving piston mounted within a barrel of the tool for driving the fastener, wherein the tool is able to receive a .22 cal×0.613 ins long unnecked charge.

In one embodiment of the invention, the charge is mounted in a charge chamber formed at the inner end of the barrel and leading into the interior of the barrel via an outlet end portion of the charge chamber, and the driving piston has in its rear face a recess in axial alignment with the outlet end portion of the charge chamber.

Advantageously, the recess in the rear face of the piston is of a volume such that the recess is able to smooth-out sharp pressure spikes and reduce peak pressure generated during combustion of the very high powered explosive charge defined above. For this purpose, the volume of the recess is preferably between 300 mm³ and 500 mm³ to ensure adequate control of peak pressure while achieving a minimum kinetic energy output of 260 joule.

Advantageously, the diameter of the piston recess is between 1.2 and 1.7 times the throat diameter at the outlet end portion of the charge chamber to effect flow reversal of unburnt powder discharged from the front part of the charge case before the flame front has reached it, the flow reversal of this unburnt powder causing it to meet the oncoming flame front. Particularly advantageously the piston recess diameter is approximately 1.4 times the throat diameter.

Preferably, to facilitate ejection of the spent cartridge case, the wall of the charge chamber is formed with a taper in the zone thereof contacted by the open front end of the charge on firing. In practice, the taper may be in the order of 10° included angle.

To facilitate simplicity of construction, the tool comprises a one-piece housing which mounts the barrel and all of the principal components of the firing mechanism. Advantageously, a cocking spring and firing pin spring of the firing mechanism extend rearwardly from the housing to abut against abutment surfaces on a handle mounted on the rear end portion of the housing thereby avoiding the need to form the housing with blind or plugged bores.

### BRIEF DESCRIPTION OF THE DRAWINGS

An embodiment of the invention will now be described by way of example only with reference to the accompany drawings in which:—

FIG. 1 is a longitudinal section of a single shot indirect acting tool in accordance with a preferred embodiment of the invention, the tool being shown in a configuration prior to cocking;

FIG. 2 is a fragmentary enlarged view of the tool of FIG. 1 to show details of the firing mechanism in a condition prior to cocking of the tool;

FIG. 3 is an enlarged view similar to FIG. 2 but showing the condition of the firing mechanism when the tool has been cocked and is ready to fire;

FIG. 4a shows a necked charge as typically used in prior single shot indirect acting tools, and FIG. 4b shows an unnecked charge as used in the tool of the preferred embodiment of the present invention;

FIG. 5 is an enlarged view showing a charge chamber at the rear end of the barrel and an associated recess formed in the rear face of the driving piston;

FIG. 5a is a view similar to FIG. 5 to show schematically how the recess acts to redirect the flow of unburnt powder at the start of firing; and

FIG. 6 is an enlarged view showing the charge chamber and its cooperation with the charge case after firing.

### DESCRIPTION OF THE PREFERRED EMBODIMENT

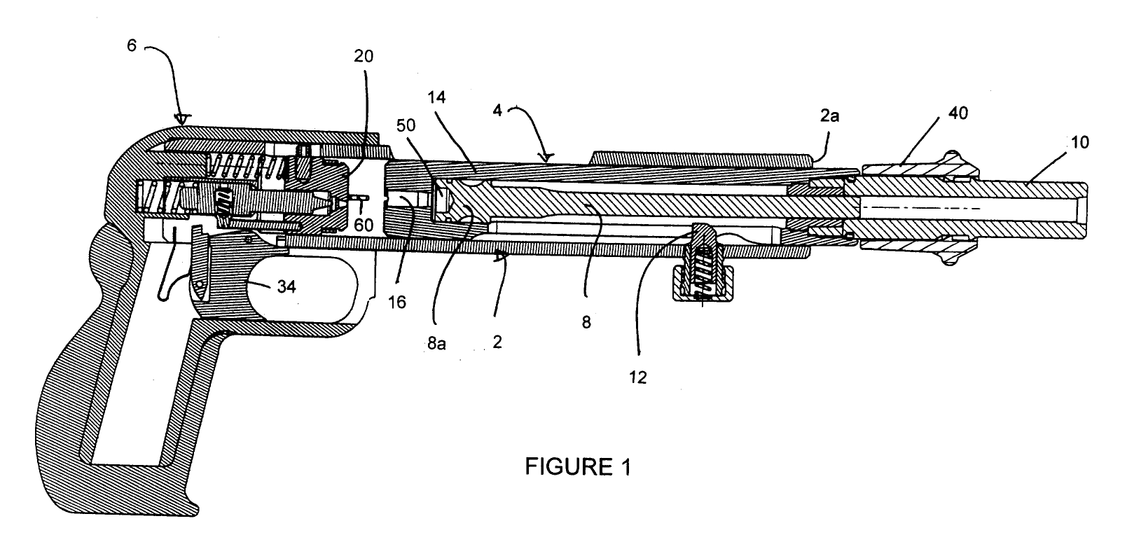

The single shot indirect acting tool shown in the accompanying drawings comprises a single-piece main housing 2 in which a barrel 4 is slideably mounted. The housing 2 also carries at its rear end all of the principal components of the firing mechanism and also a handle 6. The barrel 4 houses a fastener driving piston 8 extending forwardly into a fastener guide 10 forming the forward end portion of the barrel 4, the fastener guide 10 serving to receive a fastener inserted from the forward end as is conventional. The housing 2 carries a spring-loaded resetting pawl 12 which projects into a main body 14 of the barrel 4 via a longitudinal slot in the wall of the main body 14 to engage the head end 8a of the driving piston 8 so as to permit resetting of the piston 8 into the rear end of the barrel 4 after firing, this action being achieved by manually withdrawing the barrel 4 forwardly relative to the housing 2. This type of resetting action is very well known per se in indirect acting tools and will be well understood by those skilled in this art. At its rear end, the main body 14 of the barrel 4 is formed with a chamber 16 for receiving an explosive charge, the charge chamber 16 leading into the interior of the barrel. Manual loading of the charge into the charge chamber occurs via a breach opening formed in the main housing 2 with the barrel 4 drawn forwardly of the position shown in FIG. 1.

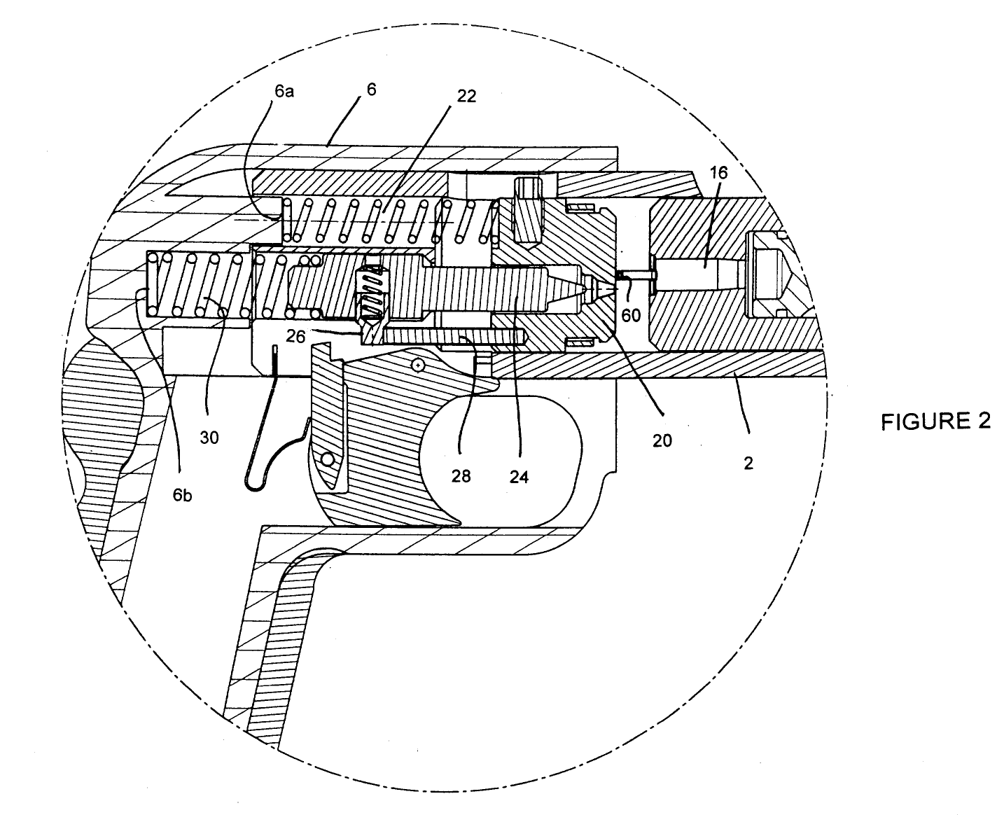

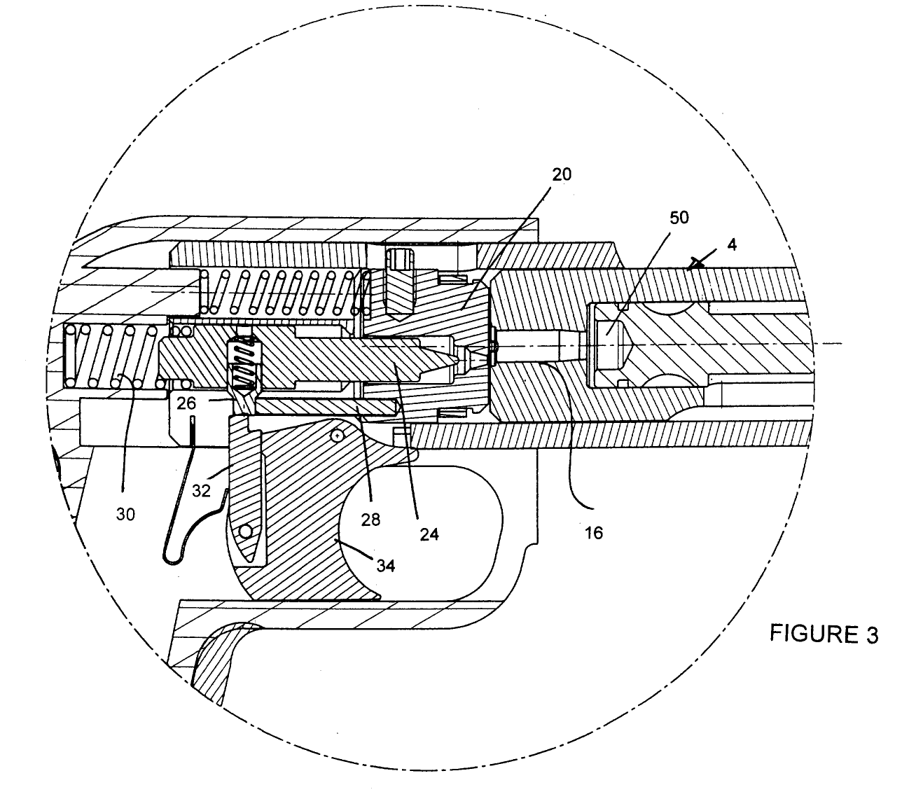

With reference to FIG. 2, the firing mechanism comprises a breach block 20 subject to axial bias by a cocking spring 22 mounted in the housing 2 and extending between the rear face of the breach block 20 and an abutment surface 6a formed by part of the handle 6 mounted on the housing 2. The breach block 20 is associated with a firing pin 24 mounted in the housing 2 and normally retained in a retracted position by interaction between a firing pin pawl 26 and a cocking rod 28 extending rearwardly from the breach block 20. The firing pin 24 is subject to the axial bias of the firing pin spring 30 mounted in the housing 2 and extending rearwardly from the firing pin 24 to abut against the base 6b of a passage formed in the handle 6. In order to cock the tool in preparation for firing after loading of the charge into the charge chamber 16 with subsequent rearwards displacement of the barrel 4 to close the breach chamber, the forward end of the barrel 4 is pressed against the component being fixed to the substrate, to displace the barrel 4 and breach block 20 in engagement with the rear of the barrel 4 rearwardly against the force of the cocking spring 22. The cocking rod 28 interacting with the firing pin pawl 26 displaces the firing pin 24 rearwardly during this movement against the bias of the firing pin spring 30 thereby loading the firing pin spring. The fully cocked condition is shown in FIG. 3 and in this condition the firing pin pawl 26 is aligned with a sear 32 of the trigger 34. Actuation of the trigger 34 in this condition causes the sear 32 to displace the firing pin pawl 26 upwardly out of restraining engagement with the cocking rod 28 whereby the firing pin 24 is then propelled forwardly at high speed to fire the explosive charge positioned in the charge chamber 16 in the end of the barrel 4 in engagement with the front of the breach block 20.

Referring again to FIG. 1, the fastener guide 10 forming the forward end portion of the barrel 4 carries a grip member 40 of sleeve-like form adapted to assist forwards displacement of the barrel 4 by manual action to reset the piston 8 after firing as previously described. The grip member 40 is mounted on the fastener guide 10 for limited axial movement relative to the fastener guide 10 and has a rearwards axial extension such that when the barrel 4 has been moved rearwardly to close the breach chamber after loading of the charge and prior to cocking of the tool, the rear end of the grip member 40 will lie adjacent to the forward end 2a of the housing 2 whereby interaction between the grip member 40 and the housing 2 will be preclude a user from attempting to cock the tool by grasping the grip member 40 to displace the barrel 4 further rearwardly. Accordingly, cocking can only be effected by displacing the barrel 4 rearwardly by pressing the forward end against the component being fixed, the limited axial movement between the grip member 40 and the barrel 4 permitting such movement of the barrel 4 in this mode. This is a safety feature with a view to minimising the possibility of so-called air firing of the tool by deliberate misuse of the tool.

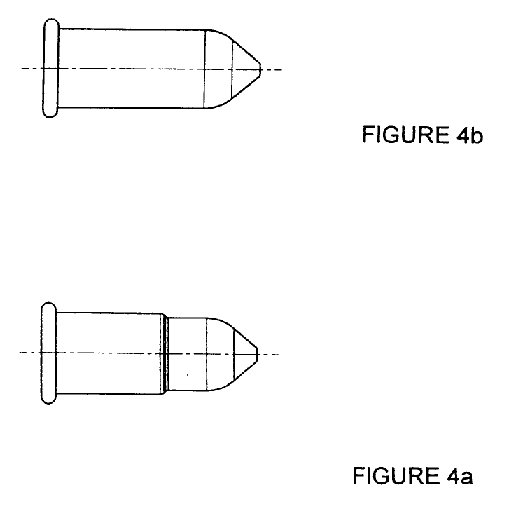

Conventionally, single-shot indirect acting tools tend to use so-called necked charges, typically a .22 calibre charge as shown in FIG. 4a. The tool in accordance with the preferred embodiment of the invention uses a .22 calibre unnecked charge as shown in FIG. 4b which has a significantly higher power than a necked charge of the same calibre. A .22 calibre unnecked charge having a length of 0.613 inches (5.6×21.1 mm) is able to achieve a piston kinetic energy of at least 260 joule thereby providing a power output comparable with that of equivalent direct acting tools. The tool in accordance with the preferred embodiment of the invention incorporates a number of design features which enable the tool to handle the higher powered charge, as will now be described.

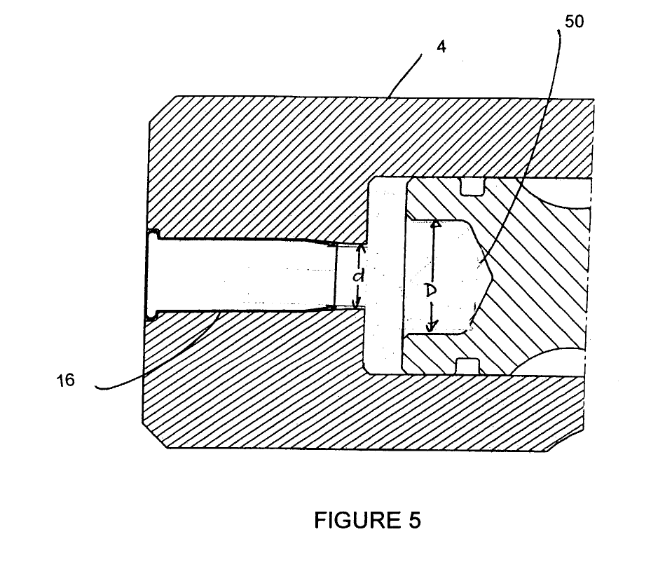

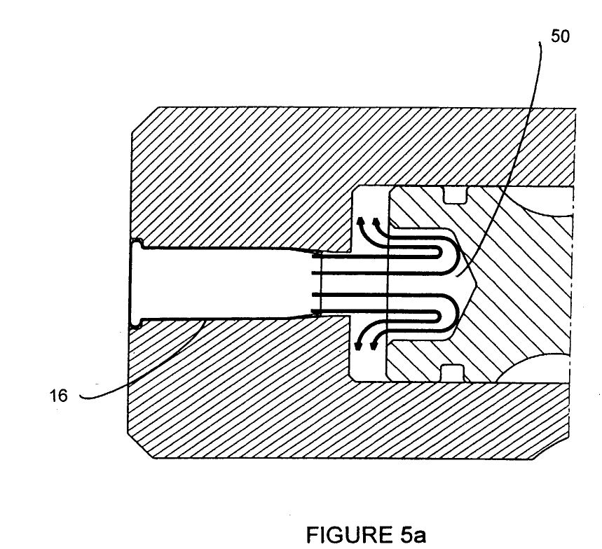

In relatively long, slender, charges of which the .22×0.613 unnecked charge is an example, a large proportion of the propellant powder is located near the front of the case of the charge. On ignition of the priming compound some of the propellant powder is expelled from the case before the flame front which originates from the base of the case, has reached it. This results in unburned powder being propelled forwardly into the combustion chamber defined between the rear end of the interior of the barrel and the rear face of the piston. This results in poor combustion of this part of the powder resulting in reduced power output and a build-up of combustion deposits. In order to avoid this effect, the rear face of the piston 8 includes a recess 50 in alignment with the charge chamber 16. We have determined that when the diameter D of the piston recess 50 is between substantially 1.2 and 1.7 times the diameter d of the throat of the charge chamber 16, in other words the diameter of the charge chamber 16 at the forward end portion thereof opening into the interior of the barrel (see FIG. 5), the unburned powder expelled from the charge case on ignition travels into the centre part of the piston recess 50 and is deflected through 180° to travel approximately parallel to the incoming hot burning gasses, but in the opposite direction thereto, produced from the combustion of the powder at the base of the case. This is illustrated schematically in FIG. 5a. During this initial period, the unburned powder is ignited in the hottest zone of the combustion chamber thereby producing minimal combustion deposits. We have determined that particularly beneficial effects are achieved when the piston recess diameter D is substantially 1.4 times the throat diameter d.

We have also determined that the throat diameter d should be between substantially 4.5 mm and 6.0 mm. If the throat diameter is below 4.5 mm excess pressure builds up within the charge case due to over-throttling of the gas flow and if the throat diameter is increased above 6.0 mm too little pressure is maintained within the case to ensure effective ignition of the powder and also the return flow of the unburned powder propelled into the piston recess 50 as just discussed. A throat diameter of substantially 5.5 mm produces particularly good results.

In addition to ensuring the return flow of unburned powder as previously discussed, the recess 50 in the piston is used to control very high peak pressures generated during combustion of the .22 calibre unnecked charge and which are significantly higher than the pressures generated of firing of a necked charge as conventionally used in indirect acting tools. Effectively, the presence of the recess 50 increases the initial volume of the combustion chamber therefore smoothing out sharp pressure spikes which arise during combustion and reducing the peak pressure. We have determined that a recess 50 with a volume of at least 300 mm³ is required to ensure that peak pressures are maintained within safe limits, and that the volume should not exceed substantially 500 mm³ to ensure generation of kinetic energy of at least 260 joule.

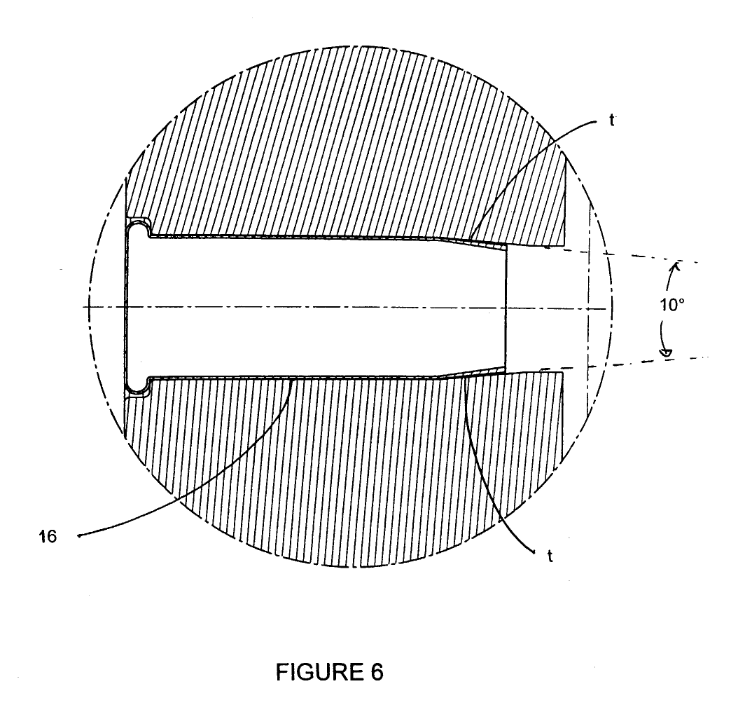

On firing of the unnecked charge, the forward end of the charge case opens in jaw-like fashion into engagement with opposed wall portions of the charge chamber 16 formed in the rear of the barrel as shown in FIG. 6. We have determined that it is beneficial for the wall of the charge chamber to have a taper t of the approximate order of 10° included angle in the zone thereof contacted by the opened end portions of the case on firing. Due to this taper the opened end of the case which is in tight engagement with the wall of the charge chamber does not lead to jamming of the spent case within the charge chamber whereby the spent case can be ejected by operation of an ejector lever 60 associated with the breach block 20 in a manner well known per se in single shot tools.

The single shot indirect acting tool particularly described, as a result of the design features discussed above is able to produce a kinetic energy output of at least 260 joule using a standard .22 calibre×0.613 inch unnecked charge whereby the tool is able to achieve a high power of output equivalent to that of a comparable direct acting tool but without safety concerns which may sometimes arise due to the very high fastener velocity achieved in the direct acting tool.

The single piece outer housing 2 which mounts the barrel 4 and firing mechanism provides a particularly simple construction and as the firing pin spring and cocking spring of the firing mechanism abut at their rear ends against parts of the handle mounted at the rear end portion of the housing, the housing itself does not require blind bores or plugged bores which would otherwise be required to provide rear abutment surfaces for these springs. Accordingly, the preferred embodiment of the invention provides a high powered indirect acting tool of relatively simple construction.

The embodiment has been described by way of example only and modifications are possible within the scope of the invention.

1. An explosively actuated tool for driving a fastener into a substrate, said tool being of indirect acting type and comprising a driving piston mounted within a barrel of the tool for driving the fastener, wherein the tool is a single shot tool able to receive an explosive charge capable of generating a piston kinetic energy of at least 260 joule.

2. An explosively actuated tool for driving a fastener into a substrate, said tool being of indirect acting type and comprising a driving piston mounted within a barrel of the tool for driving the fastener, wherein the tool is able to receive a .22 cal×0.613 ins long unnecked charge.

3. A tool according to claim 1 or claim 2, wherein the charge is mounted in a charge chamber formed at the inner end of the barrel and leading into the interior of the barrel via an outlet end portion of the charge chamber, and the driving piston has in its rear face a recess in axial alignment with the outlet end portion of the charge chamber.

4. A tool according to claim 3, wherein the recess in the rear face of the piston is of a volume such that the recess is able to smooth-out sharp pressure spikes and reduce peak pressure generated during combustion of the explosive charge.

5. A tool according to claim 4 wherein the volume of the recess is between 300 mm³ and 500 mm³.

6. A tool according to claim 3, wherein the diameter of the piston recess is between 1.2 and 1.7 times the throat diameter at the outlet end portion of the charge chamber to effect flow reversal of unburnt powder discharged from the front part of the charge case before the flame front has reached it, such that the flow reversal of this unburnt powder causes it to meet the oncoming flame front.

7. A tool according to claim 6, wherein the piston recess diameter is approximately 1.4 times the throat diameter.

8. A tool according to claim 6, wherein the throat diameter is between substantially 4.5 mm and 6.0 mm.

9. A tool according to claim 3, wherein to facilitate ejection of the spent cartridge case, the wall of the charge chamber is formed with a taper in the zone thereof contacted by the open front end of the charge on firing.
